(19) United States
(12) Patent Application Publication
(10) Pub. No.: US 2023/0207849 A1
(43) Pub. Date: Jun. 29, 2023

(54) MEMBRANE-ELECTRODE ASSEMBLY FOR FUEL CELLS

(71) Applicants: Hyundai Motor Company, Seoul (KR); Kia Corporation, Seoul (KR)

(72) Inventor: Myung Young An, Incheon (KR)

(21) Appl. No.: 18/079,279

(22) Filed: Dec. 12, 2022

(30) Foreign Application Priority Data
Dec. 27, 2021 (KR) 10-2021-0188309

(51) Int. Cl. H01M 8/1004; H01M 8/0273

(52) U.S. Cl. CPC H01M 8/1004; H01M 8/0273

(57) ABSTRACT

Disclosed is a membrane-electrode assembly for fuel cells that can improve durability and prevent reduction in a lifespan thereof. The membrane-electrode assembly for fuel cells includes a pair of electrodes, an electrolyte membrane stacked between the electrodes, the which includes a membrane extension member extending outside the electrodes, a sub-gasket bonded to both surfaces of the membrane extension member, which includes an upper gasket and a lower gasket extending outside the membrane extension member and being bonded to each other, and an opening formed in at least one of the upper gasket and the lower gasket so as to discharge water produced during an electrochemical reaction occurring in the electrodes, which is adjacent to the membrane extension member.

### CROSS-REFERENCE TO RELATED APPLICATION

This application claims under 35 U.S.C. § 119(a) the benefit of priority to Korean Patent Application No. 10-2021-0188309, filed on Dec. 27, 2021, the entire contents of which are incorporated herein by reference.

### TECHNICAL FIELD

The present disclosure relates to a membrane-electrode assembly for fuel cells that can improve durability and prevent reduction in a lifespan thereof.

### BACKGROUND

In general, a fuel cell has been used in the form of a stack including a plurality of fuel cells which is laminated and assembled to satisfy a required output level. Each fuel cell includes a membrane-electrode assembly (MEA), a gas diffusion layer (GDL), and a separator and an electrochemical reaction for generating electricity in the fuel cell occurs in the membrane-electrode assembly.

The membrane-electrode assembly includes an electrolyte membrane and a pair of electrodes bonded to respective surfaces of the electrolyte membrane. Such a membrane-electrode assembly is provided with a sub-gasket at an outer portion thereof.

As shown in FIG. 5, the electrolyte membrane 1 of a recently developed membrane-electrode assembly has a size extending to the outer end of the sub-gasket 2 and is bonded to the sub-gasket 2 via an adhesive applied to the surface thereof. The sub-gasket 2 covers the outer portion of the electrolyte membrane 1 in the form of a sandwich, and also covers the surface edge of the electrode 3.

However, when the electrolyte membrane 1 is formed to a size extending to the outer end of the sub-gasket 2, the material of the electrolyte membrane is also used over an area not required for the electrochemical reaction, and the outer peripheral surface of the electrolyte membrane is exposed, rather than being covered with the sub-gasket. The exposed outer peripheral surface of the electrolyte membrane may be used as an inflow passage for impurities causing side reactions and thus may reduce the lifespan of the membrane-electrode assembly.

On the other hand, when the electrolyte membrane is formed to a size that does not reach the outer end of the sub-gasket, blisters may be often formed due to side reactions, thus reducing the durability of the membrane-electrode assembly.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

In preferred aspects, provided is a membrane-electrode assembly for fuel cells that is capable of improving durability and preventing a reduction in lifespan by increasing the blister resistance of a sub-gasket.

The objects of the present disclosure are not limited to those described above. Other objects of the present disclosure will be clearly understood from the following description, and are able to be implemented by means defined in the claims and combinations thereof.

In an aspect, provided is a membrane-electrode assembly for fuel cells including a pair of electrodes, an electrolyte membrane stacked between the electrodes, the electrolyte membrane including a membrane extension member extending outside the electrodes, a sub-gasket bonded to both surfaces of the membrane extension member, the sub-gasket including an upper gasket and a lower gasket extending outside the membrane extension member and being bonded to each other, and an opening formed in at least one of the upper gasket and the lower gasket so as to discharge water produced during an electrochemical reaction occurring in the electrodes, the opening being adjacent to the membrane extension member.

The opening may include a plurality of water outlets spaced apart from each other in a circumferential direction of the membrane extension member. The plurality of water outlets may be spaced apart regularly (e.g., at predetermined distance) or irregularly from each other in the circumferential direction of the membrane extension member.

Each of the water outlets may be adjacent to any one of an upper surface of the membrane extension member and a lower surface of the membrane extension member.

Each of the water outlets may extend from an upper surface of the upper gasket to a lower surface of the upper gasket or extends from an upper surface of the lower gasket to a lower surface of the lower gasket.

Each of the water outlets may be formed to have a width less than a width of the membrane extension member.

The upper gasket may include an upper base film layer, and an upper adhesive layer formed on a lower surface of the upper base film layer, the upper adhesive layer bonded to an upper surface of the membrane extension member. The lower gasket may include a lower base film layer, and a lower adhesive layer formed on an upper surface of the lower base film layer, the lower adhesive layer bonded to a lower surface of the membrane extension member and the upper adhesive layer.

At least one of the upper adhesive layer and the lower adhesive layer may have a water content of 0.6 wt % to 8.0 wt %, each respectively based on the weight of upper adhesive later or lower adhesive layer, and at least one of the upper adhesive layer and the lower adhesive layer may have an adhesive force of about 5 N/cm to 16 N/cm.

The upper gasket may be formed to cover an edge of an upper electrode of the electrodes and the lower gasket may be formed to cover an edge of a lower electrode of the electrodes.

Also provided is a fuel cell including the membrane-electrode assembly as described herein.

Further provided is a vehicle that includes the fuel cell as described herein.

Other aspects of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a membrane-electrode assembly for fuel cells according to an exemplary embodiment of the present disclosure;

FIG. 2 shows a cross-sectional view taken along line A-A of FIG. 1;

FIG. 3 shows a cross-sectional structure and a water discharge mechanism of a membrane-electrode assembly according to an exemplary embodiment of the present disclosure;

FIG. 4 shows a mechanism by which blisters are formed in the membrane-electrode assembly of the present disclosure, to which a water outlet is not applied; and

FIG. 5 shows a cross-sectional view illustrating a cross-sectional structure of a conventional membrane-electrode assembly.

### DETAILED DESCRIPTION

Specific structural or functional descriptions presented in the embodiments of the present disclosure are only provided to illustrate embodiments according to the concept of the present disclosure and the embodiments according to the concept of the present disclosure may be implemented in various forms.

It will be understood that the term “comprises”, when used in this specification, specifies the presence of the stated element, but does not preclude the presence or addition of one or more other elements unless stated otherwise. Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, embodiments of the present disclosure will be described with reference to the accompanying drawings. The contents expressed in the attached drawings may be illustrated schematically for easy illustration of the embodiments of the present disclosure, and may be different from those actually implemented in real-world embodiments.

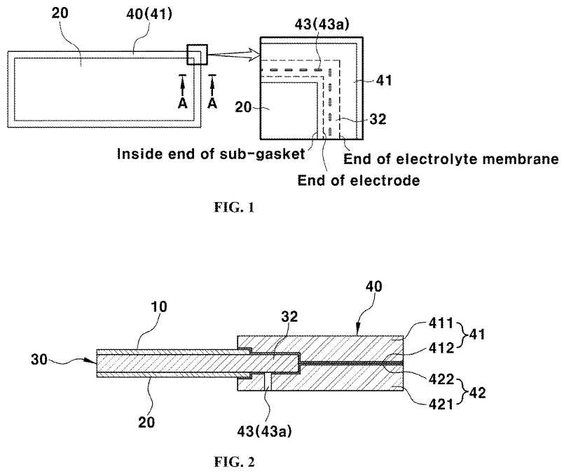

As shown in FIGS. 1 and 2, the membrane-electrode assembly for fuel cells includes a pair of electrodes 10 and 20, an electrolyte membrane 20, and a sub-gasket 40.

The pair of electrodes 10 and 20 includes an upper electrode 10 stacked on and joined to an upper surface of the electrolyte membrane 20 and a lower electrode 20 stacked on and joined to a lower surface of the electrolyte membrane 20. The upper electrode 10 and the lower electrode 20 may be the same size. The upper electrode 10 may be referred to as a “cathode”, and the lower electrode 20 may be referred to as an “anode”.

Hereinafter, the direction in which of the upper electrode 10, the electrolyte membrane 20, and the lower electrode 20 are stacked is referred to as a “vertical direction”. The stacking direction is the same as the thickness direction of the electrolyte membrane 20. Also, a direction perpendicular to the vertical direction is referred to as a “horizontal direction”.

The electrolyte membrane 20 is stacked between a pair of electrodes 10 and 20, for example, electrolyte membrane 20 is stacked between the upper electrode 10 and the lower electrode 20.

The electrolyte membrane 20 is formed to have a horizontal width greater than the horizontal width of the upper electrode 10 and the lower electrode 20. In this case, the protrusion on the electrolyte membrane 20 disposed on the outside of the upper electrode 10 and the lower electrode 20 is referred to as a “membrane extension member” 32, for example, the electrolyte membrane 20 includes an upper electrode 10 and a membrane extension member 32 formed to extend outwards from the lower electrode 20. The membrane extension member 32 extends in the circumferential direction of the electrolyte membrane 20.

The sub-gasket 40 includes an upper gasket 41 and a lower gasket 42 bonded to respective surfaces of the membrane extension member 32.

The upper gasket 41 is bonded to the upper surface of the membrane extension part 32, and is formed in the form of a substantially rectangular loop to open the central part of the upper electrode 10. The upper gasket 41 is bonded from the upper surface edge of the upper electrode to the upper surface of the membrane extension member 32. Only the edge of the upper surface of the upper electrode 10 is covered with the upper gasket 41, and the portion excluding the edge of the upper surface thereof (i.e., the central portion of the upper surface) is not covered with the upper gasket 41.

The lower gasket 42 is bonded to the lower surface of the membrane extension member 32 and is formed in the form of a substantially rectangular loop to open the central part of the lower electrode 20. The lower gasket 42 is bonded from the lower surface edge of the lower electrode to the lower surface of the membrane extension member 32. Only the edge of the lower surface of the lower electrode 20 is covered with the lower gasket 42 and portions excluding the edge of the lower surface thereof (i.e., the central portion of the lower surface) are not covered with the lower gasket 42.

In addition, the upper gasket 41 and the lower gasket 42 extend outside the membrane extension member 32 and are bonded to each other, for example, the upper gasket 41 and the lower gasket 42 are bonded to the surface of the membrane extension member 32 while being bonded to each other at the outside of the membrane extension member 32.

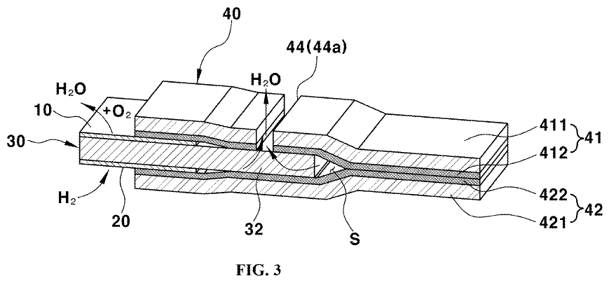

The sub-gasket 40 configured in this way has openings 43 and 44 as shown in FIGS. 2 and 3 to discharge water generated in the course of the electrochemical reaction of the reaction gas in the upper electrode 10 and the lower electrode 20. The reaction gas includes hydrogen, which is a fuel of the fuel cell, and oxygen, which is an oxidizing agent.

The openings 43 and 44 are formed in at least one of the upper gasket 41 and the lower gasket 42, and are configured to discharge water generated in the upper electrode 10 and the lower electrode 20.

The openings 43 and 44 are disposed adjacent to the membrane extension member 32 to effectively discharge water. Particularly, the openings 43 and 44 include a plurality of water outlets 43a and 44a spaced apart from each other in the circumferential direction of the membrane extension member 32.

The water outlets 43a and 44a may be provided in the lower gasket 42, as shown in FIG. 2, or may be provided in the upper gasket 41, as shown in FIG. 3. The water outlets 43a and 44a may be provided in both the upper gasket 41 and the lower gasket 42.

When the water outlet 44a is formed in the upper gasket 41, as shown in FIG. 3, the water outlet 44a is formed to extend from the upper surface to the lower surface of the upper gasket 41. Here, the water outlet 44a is adjacent to the upper surface of the membrane extension member 32.

In addition, when the water outlet 43a is formed in the lower gasket 42, as shown in FIG. 2, it is formed to extend from the upper surface to the lower surface of the lower gasket 42. Here, the water outlet 43a is adjacent to the lower surface of the membrane extension member 32.

In addition, the water outlets 43a and 44a are formed to have a horizontal width less than the horizontal width of the membrane extension member 32. Here, the water outlet 43a or 44a is disposed between the end of the electrode 10 or 20 and the end of the electrolyte membrane 20. The water outlet 43a or 44a is disposed between the horizontal end of the electrode 10 or 20 and the horizontal end of the membrane extension member 32.

The water outlets 43a and 44a may have any of various cross-sectional shapes, such as a square, a circle, an oval, and the like, and are not limited with regard to the shape thereof.

As shown in FIGS. 2 and 3, the upper gasket 41 includes an upper base film layer 411 and an upper adhesive layer 412 formed on the lower surface of the upper base film layer 411, and the lower gasket 42 includes a lower base film layer 421 and a lower adhesive layer 422 formed on the upper surface of the lower base film layer 421.

The upper adhesive layer 412 is bonded to the upper surface edge of the upper electrode and the upper surface of the membrane extension member 32. The lower adhesive layer 422 is bonded to the lower surface edge of the lower electrode 20 and the lower surface of the membrane extension member 32, and is also bonded to the lower surface of the upper adhesive layer 412 at the outside of the membrane extension member 32.

When the water outlet 44a is formed in the upper gasket 41, it extends from the upper part of the upper base film layer 411 to the lower part of the upper adhesive layer 412. In addition, when the water outlet 43a is formed in the lower gasket 42, it extends from the lower part of the lower base film layer 421 to the upper part of the lower adhesive layer 422.

FIG. 1 shows a plan view illustrating an exemplary membrane-electrode assembly according to an exemplary embodiment of the present disclosure, FIG. 2 shows a cross-sectional structure taken along line A-A of FIG. 1, and FIG. 3 shows a cross-sectional structure of a membrane-electrode assembly according to another exemplary embodiment of the present disclosure in greater detail than is shown in FIG. 2. When the cross-sectional structure of the membrane-electrode assembly shown in FIG. 2 is illustrated in greater detail, the cross-sectional structure of the membrane-electrode assembly shown in FIG. 3 is the same as the membrane-electrode assembly shown in FIG. 3 except that the water outlet 43a is formed in the lower gasket 42.

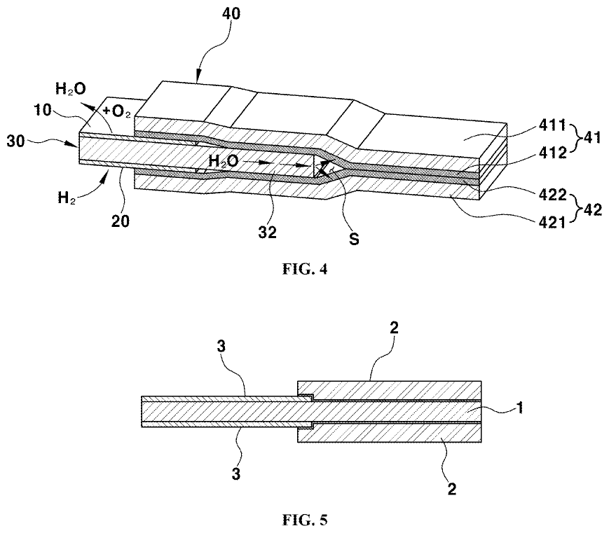

In addition, FIG. 4 illustrates the membrane-electrode assembly of the present disclosure to which the water outlets 43a and 44a are not applied. FIG. 4 has the same cross-sectional structure as the membrane-electrode assembly shown in FIG. 3, except that the water outlets 43a and 44a are provided.

As shown in FIGS. 3 and 4, the membrane-electrode assembly includes a void (S) between the upper gasket 41 and the lower gasket 42 depending on the thickness of the membrane extension member 32. The void (S) is a space adjacent to the end of the membrane extension member 32.

The mechanism by which blisters are formed in the adhesive layers 412 and 422 of the sub-gasket 40 will be described with reference to FIG. 4.

In general, in a membrane-electrode assembly for fuel cells, hydrogen (H₂) supplied to an anode is ionized to a proton (H⁺) which passes through an electrolyte membrane and is then bonded to oxygen (O₂) at a cathode to produce water (H₂O). In addition, in the membrane-electrode assembly, blisters are formed as water, free acids, and radicals generated on the surfaces of the electrolyte membrane and the cathode move along the surface of the electrolyte membrane.

In the membrane-electrode assembly, a normal reaction in which water is produced (i.e., a forward reaction) and an abnormal reaction which forms blisters (i.e., a side reaction) occur competitively. In the membrane-electrode assembly, because the size of the electrolyte membrane is larger than that of the electrode, the forward reaction occurs overwhelmingly more than the side reaction.

However, when, like the membrane-electrode assembly shown in FIG. 4, the horizontal length of the electrolyte membrane 20 is less than the horizontal length of the sub-gasket 40 and thus the end of the electrolyte membrane 20 is disposed inside the sub-gasket 40, the probability of occurrence of the side reaction increases because the resistance of the water to move to the void S formed at the end of the electrolyte membrane 20 is low compared to the resistance of the water to pass through the electrolyte membrane 20.

In the membrane-electrode assembly having a void S as shown in FIG. 4, water, radicals, and free acids generated on the surfaces of the electrolyte membrane 20 and the electrodes 10 and are collected in the void S to form blisters, and the adhesive layers 412 and 422 exposed to the blisters are swollen, whereby adhesive strength decreases. When the swelling pressure of the blisters is greater than the adhesive strength of the adhesive layers 412 and 422, the blisters expand, thus causing deterioration in the durability of the membrane-electrode assembly.

On the other hand, as shown in the membrane-electrode assembly in FIG. 3, the opening 44 adjacent to the membrane extension member 32 is formed in the sub-gasket 40, water is discharged through the opening 44, thus reducing the amount of water moved to the void S.

In addition, in the membrane-electrode assembly of the present disclosure, when the concentration of water, radicals and free acids increases in the void (S), and thus swelling resistance of the adhesive layers 412 and 422 is formed, the concentration of water, radicals, and free acids is redistributed to thereby realize a relatively low concentration due to the thermodynamic properties of the electrolyte membrane 20, thus causing water to be discharged through the water outlets 43a and 44a. Accordingly, the adhesive layers 412 and 422 of the sub-gasket 40 do not swell.

When adhesive layers 412 and 422 have insufficient resistance, such as adhesion and swelling resistance, blisters may be formed in adhesive layers 412 and 422 before the water, radicals and free acids collected in the void S are discharged to the outside through the water outlets 43a and 44a.

Accordingly, the adhesive layers 412 and 422 of the sub-gasket 40 include an adhesive capable of suppressing the occurrence of blisters, thereby increasing water discharge through the water outlets 43a and 44a.

Particularly, the upper adhesive layer 412 and the lower adhesive layer 422 of the sub-gasket 40 are formed of an adhesive material having properties of not retaining water and of not being swollen by water. For this purpose, the upper adhesive layer 412 and the lower adhesive layer 422 are formed of an adhesive having a water content of 8% or less. The upper adhesive layer 412 and the lower adhesive layer 422 are formed of an adhesive each respectively having a water content of about 0.6 wt % to 8.0 wt % based the total weight of each adhesive layer.

In addition, the upper adhesive layer 412 and the lower adhesive layer 422 are formed of a material having a property whereby a minimum adhesive strength is maintained even if water is taken in. The upper adhesive layer 412 and the lower adhesive layer 422 maintain a state in which the upper adhesive layer 412 and the lower adhesive layer 422 are bonded to each other and are separated from each other even if they take in water.

To this end, the adhesive layers 412 and 422 are formed of an adhesive having a hot-water adhesive strength of about 5 N/cm or greater. The upper adhesive layer 412 and the lower adhesive layer 422 are formed of an adhesive having a hot-water adhesive strength of 5 N/cm to 16 N/cm.

The upper adhesive layer 412 and the lower adhesive layer 422 are formed of a material having a water content and a hot-water adhesive strength within the range described above, thereby maximizing the water discharging effect of the water outlets 43a and 44a.

A general adhesive strength means the adhesive strength at room temperature, whereas the hot-water adhesive strength means the adhesive strength of the adhesive layers 412 and 422 measured after immersing the adhesive layers 412 and 422 in water at a predetermined temperature for a predetermined time. Accordingly, the hot-water adhesive strength may be referred to as “heat-resistance and water-resistance adhesive strength”. In addition, the predetermined temperature to measure the hot-water adhesive strength may be set as the highest temperature value of water generated during the electrochemical reaction of the membrane-electrode assembly for fuel cells. In other words, the hot-water adhesive strength may be determined as the maximum operation temperature of the fuel cell.

The adhesive layers 412 and 422 may suppress the occurrence of blisters as the water content thereof decreases. However, when the water content of the adhesive layers 412 and 422 is less than about 0.6% set as the minimum value, the adhesive layers 412 and 422 have a hydrophobic or water-repellent molecular structure and have difficulty in adsorbing the electrolyte membrane 30 having a hydrophilic surface. In this case, the adhesive strength between the electrolyte membrane 30 and the electrodes 10 and 20 is reduced, making it impossible to manufacture the membrane-electrode assembly, or greatly reducing the durability of the membrane-electrode assembly. In addition, when the water content of the adhesive layers 412 and 422 is greater than about 8.0% set as the maximum value, the adhesive layers 412 and 422 swell while absorbing water of the electrolyte membrane 30. Accordingly, the cohesive force and the interfacial bonding strength of the adhesive layers 412 and 422 are decreased and the risk of blistering of the adhesive layers 412 and 422 is increased.

In addition, the adhesive layers 412 and 422 are advantageous in suppressing the occurrence and swelling of blisters as the hot-water adhesive strength thereof increases. However, when the hot-water adhesive strength is greater than about 16 N/cm, the adhesive strength between the upper adhesive layer 412 and the lower adhesive layer 422 is increased to suppress blister swelling of the adhesive layers 412 and 422. During durability evaluation, water is absorbed by the electrolyte membrane 30 of the membrane-electrode assembly having a hydrophilic interface and thus the electrolyte membrane 30 has a hydrophilic interface, and the interface of the adhesive layers 412 and 422 attached to the surface of the membrane extension member 32 of the electrolyte membrane 30 acts as a foreign material that prevents adhesion due to water. As a result, the adhesive strength between the electrolyte membrane 30 and the adhesive layers 412 and 422 is reduced and the force for suppressing the occurrence and swelling of blisters in the void S is reduced, so the gap between the electrolyte membrane 30 and the adhesive layer 412 and 412 and 422 increases.

Further, when the water content of the adhesive layers 412 and 422 is about 0.6% or less and the hot-water adhesive strength of the adhesive layers 412 and 422 is greater than about 16 N/cm, the hydrophobicity of the adhesive layers 412 and 422 is very high and thus the water content and the hot-water adhesive strength are maintained, but the adhesive strength between the membrane extension member 32 of the electrolyte membrane 30 having a hydrophilic interface and the adhesive layers 412 and 422 is greatly reduced, so the gap between the membrane extension member 32 and the adhesive layers 412 and 422 increases.

Therefore, when the hot-water adhesive strength of the adhesive layers 412 and 422 is greater than about 16 N/cm, it is difficult to improve the water discharge performance of the water outlets 43a and 44a.

In addition, as an adhesive having a water content of about 0.6% to 8.0% and a hot-water adhesive strength of about 5 N/cm to 16 N/cm, for example, an epoxy-based adhesive, a polyolefin-based adhesive, a urethane/epoxy mixed adhesive, or the like may be used.

In addition, the adhesive includes acrylate-based adhesives, silicone-based adhesives, polyimide-based adhesives, polyester-based adhesives, Teflon-based adhesives, urethane-based adhesives, rubber-based adhesives, and the like. There is no particular limitation as to the type of adhesive in the present disclosure.

Meanwhile, in order to evaluate the blister-resistance performance of the adhesive layers 412 and 422 having the physical properties descried above and to determine whether or not blisters are generated depending on the presence or absence of the water outlets 43a and 44a, fuel cells were manufactured using the membrane-electrode assemblies produced under the conditions shown in Table 1 below, and the occurrence of blisters during electricity generation by each fuel cell was observed.

### Examples 1 to 3

Membrane-electrode assemblies including an adhesive layer having a water content and a hot-water adhesive strength shown in Table 1 below and a water outlet were manufactured, and then a fuel cell was manufactured using each membrane-electrode assembly. At this time, an adhesive layer formed of a polyolefin material was used, and the hot-water adhesive strength of the adhesive layer was measured after immersing an adhesive layer specimen having a width of 1 cm and a length of 9 cm in DI water at a temperature of 90° C. for 100 hours.

### Comparative Example 1

A membrane-electrode assembly was manufactured under the same conditions as in Example 1 except that the water outlet was not formed, and then a fuel cell was manufactured using the membrane-electrode assembly.

### Comparative Example 2

A membrane-electrode assembly was manufactured under the same conditions as in Example 2 except that the water outlet was not formed, and then a fuel cell was manufactured using the membrane-electrode assembly.

### Comparative Example 3

A membrane-electrode assembly was manufactured under the same conditions as in Example 3 except that the water outlet was not formed, and then a fuel cell was manufactured using the membrane-electrode assembly.

### Comparative Example 4

A membrane-electrode assembly was manufactured under the same conditions as in Example 1 except that the water content was changed, and then a fuel cell was manufactured using the membrane-electrode assembly.

### Comparative Example 5

A membrane-electrode assembly was manufactured under the same conditions as in Example 2 except that the water content was changed, and then a fuel cell was manufactured using the membrane-electrode assembly.

### Comparative Example 6

A membrane-electrode assembly was manufactured under the same conditions as in Example 3 except that the water content was changed, and then a fuel cell was manufactured using the membrane-electrode assembly.

### Comparative Example 7

A membrane-electrode assembly was manufactured under the same conditions as in Example 1 except that the hot-water adhesive strength was changed, and then a fuel cell was manufactured using the membrane-electrode assembly.

### Comparative Example 8

A membrane-electrode assembly was manufactured under the same conditions as in Example 2 except that the hot-water adhesive strength was changed, and then a fuel cell was manufactured using the membrane-electrode assembly.

### Comparative Example 9

A membrane-electrode assembly was manufactured under the same conditions as in Example 3 except that the hot-water adhesive strength was changed, and then a fuel cell was manufactured using the membrane-electrode assembly.

### Comparative Examples 10 and 11

A membrane-electrode assembly was manufactured under the same conditions as in Examples 1 to 3 except that the water content and hot-water adhesive strength were changed, and then a fuel cell was manufactured using the membrane-electrode assembly.

TABLE 1

| | Water | Hot-water | Presence or | Whether blisters |
|---|---|---|---|---|
| | content | adhesive | absence of | are formed or |
| | (%) | strength | water outlet | not |
| Example 1 | 7.7 | 5.3 | Present | Unformed |
| Example 2 | 4.7 | 13.3 | Present | Unformed |
| Example 3 | 0.6 | 15.7 | Present | Unformed |
| Comparative | 7.7 | 5.3 | Absent | Formed |
| Example 1 | | | | |
| Comparative | 4.7 | 13.3 | Absent | Formed |
| Example 2 | | | | |
| Comparative | 0.6 | 15.7 | Absent | Formed |
| Example 3 | | | | |
| Comparative | 8.7 | 5.3 | Present | Formed |
| Example 4 | | | | |
| Comparative | 8.7 | 13.3 | Present | Formed |
| Example 5 | | | | |
| Comparative | 8.7 | 15.7 | Present | Formed |
| Example 6 | | | | |
| Comparative | 7.7 | 4.4 | Present | Formed |
| Example 7 | | | | |
| Comparative | 4.7 | 4.4 | Present | Formed |
| Example 8 | | | | |
| Comparative | 0.6 | 4.4 | Present | Formed |
| Example 9 | | | | |
| Comparative | 8.7 | 4.4 | Present | Formed |
| Example 10 | | | | |
| Comparative | 0.2 | 17.6 | Present | Impossible to |
| Example 11 | | | | manufacture |
| | | | | MEA |

The fuel cells manufactured in Examples 1 to 3 and in Comparative Examples 1 to 11 were each operated at a relative humidity of 100%, an operating temperature of 40° C., and a constant current of 1.0 A/cm² for 100 hours, and whether or not blisters were formed were observed. The results of observation are shown in Table 1 above.

As shown in Table 1 above, in the fuel cells manufactured in Examples 1 to 3, no blisters were formed in the adhesive layer of the sub-gasket. In contrast, in Comparative Examples 1 to 3, in which fuel cells were manufactured under the same conditions as in Examples 1 to 3 except that the water outlet was not formed, blisters were formed in the adhesive layer of the sub-gasket.

In addition, in Comparative Examples 4 to 6, in which the fuel cells were manufactured under the same conditions as in Examples 1 to 3 except that the water content was changed, blisters were formed in the adhesive layer of the sub-gasket.

In addition, in Comparative Examples 7 to 9, in which the fuel cells were manufactured under the same conditions as in Examples 1 to 3 except that the hot-water adhesive strength was changed, blisters were formed in the adhesive layer of the sub-gasket.

In addition, in Comparative Example 10, in which fuel cells were manufactured under the same conditions as in Examples 1 to 3 except that the water content and hot-water adhesive strength were changed, blisters were formed in the adhesive layer of the sub-gasket.

However, in Comparative Example 11, the fuel cell was manufactured under the same conditions as in Example 3 except that the water content and hot-water adhesive strength were changed, and it was impossible to manufacture a normal membrane-electrode assembly due to poor adhesion between the electrolyte membrane and the adhesive layer.

When the water content of the adhesive layer is than about 0.6%, the strength of adsorption of the adhesive layer to the electrolyte membrane may be reduced due to the difference in surface properties between the hydrophobic adhesive layer and the hydrophilic electrolyte membrane, it is difficult to manufacture the membrane-electrode assembly due to the lowered adhesion strength between the electrolyte membrane and the electrode, and the durability of the membrane-electrode assembly is lowered due to the decreased adhesion between the electrolyte membrane and the adhesive layer. Accordingly, in the present disclosure, the adhesive layers 412 and 422 of the sub-gasket 40 have a water content of about 0.6% or greater.

According to various exemplary embodiments of the present disclosure, the formation of blisters in the adhesive layer of the sub-gasket may be suppressed thereby improving the durability of the membrane-electrode assembly. In addition, unnecessary use of the electrolyte membrane can be avoided.

The effects of the present disclosure are not limited to those mentioned above. It should be understood that the effects of the present disclosure include all effects that can be inferred from the description of the present disclosure.

The present disclosure has been described in detail with reference to embodiments thereof. However, it will be appreciated by those skilled in the art that changes may be made in these examples without departing from the principles and spirit of the present disclosure, the scope of which is defined in the appended claims and their equivalents.

What is claimed is:

1. A membrane-electrode assembly for fuel cells comprising:
a pair of electrodes;
an electrolyte membrane stacked between the electrodes, the electrolyte membrane comprising a membrane extension member extending outside the electrodes;
a sub-gasket bonded to both surfaces of the membrane extension member, the sub-gasket comprising an upper gasket and a lower gasket extending outside the membrane extension member and being bonded to each other; and
an opening formed in at least one of the upper gasket and the lower gasket so as to discharge water produced during an electrochemical reaction occurring in the electrodes, the opening being adjacent to the membrane extension member.

2. The membrane-electrode assembly for fuel cells according to claim 1, wherein the opening comprises a plurality of water outlets spaced apart from each other in a circumferential direction of the membrane extension member.

3. The membrane-electrode assembly for fuel cells according to claim 2, wherein each of the water outlets is adjacent to any one of an upper surface of the membrane extension member and a lower surface of the membrane extension member.

4. The membrane-electrode assembly for fuel cells according to claim 2, wherein each of the water outlets extends from an upper surface of the upper gasket to a lower surface of the upper gasket or extends from an upper surface of the lower gasket to a lower surface of the lower gasket.

5. The membrane-electrode assembly for fuel cells according to claim 2, wherein each of the water outlets is formed to have a width less than a width of the membrane extension member.

6. The membrane-electrode assembly for fuel cells according to claim 1, wherein the upper gasket comprises:
an upper base film layer; and
an upper adhesive layer formed on a lower surface of the upper base film layer; the upper adhesive layer bonded to an upper surface of the membrane extension member.

7. The membrane-electrode assembly for fuel cells according to claim 6, wherein the lower gasket comprises:
a lower base film layer; and
a lower adhesive layer formed on an upper surface of the lower base film layer, the lower adhesive layer bonded to a lower surface of the membrane extension member and the upper adhesive layer.

8. The membrane-electrode assembly for fuel cells according to claim 7, wherein at least one of the upper adhesive layer and the lower adhesive layer has a water content of about 0.6 wt % to 8.0 wt % based on the total weight of each adhesive layer, and at least one of the upper adhesive layer and the lower adhesive layer has an adhesive force of about 5 N/cm to 16 N/cm.

9. The membrane-electrode assembly for fuel cells according to claim 1, wherein the upper gasket is formed to cover an edge of an upper electrode of the electrodes and the lower gasket is formed to cover an edge of a lower electrode of the electrodes.

10. A fuel cell comprising a membrane-electrode assembly of claim 1.

11. A vehicle comprising a fuel cell of claim 10.
